(19) United States
(12) Patent Application Publication
(10) Pub. No.: US 2008/0148343 A1
(43) Pub. Date: Jun. 19, 2008

(54) DEBUGGING SECURITY MECHANISM FOR SOC ASIC

(75) Inventor: Masayoshi Taniguchi, Shiga-ken (JP)

Correspondence Address: LAW OFFICES OF MICHAEL DRYJA, 1474 N COOPER RD #105-248, GILBERT, AZ, 85233, US

(73) Assignee: INTERNATIONAL BUSINESS MACHINES CORPORATION, Armonk, NY (US)

(21) Appl. No.: 11/612,814

(22) Filed: Dec. 19, 2006

(51) Int. Cl. G06F 17/00; G06F 11/00

(52) U.S. Cl. 726/1; 714/25; 714/E11.017

(57) ABSTRACT

A system-on-chip (SoC) application-specific integrated circuit (ASIC) includes a processor, a finite state machine (FSM), and a security mechanism. The processor exposes debugging ports. The FSM permits permit instructions to be externally input to the debugging ports and data to be externally output from the debugging ports. The security mechanism prevents access to at least a subset of the debugging ports unless a security code externally input via a security interface of the security mechanism matches a predetermined internally stored security code. Additionally or alternatively, the security mechanism prevents at least a subset of the instructions from being processed unless a security code externally input via a security code instruction asserted on the debugging ports matches the predetermined internally stored security code.

### FIELD OF THE INVENTION

The present invention relates generally to system-on-chip (SoC) application-specific integrated circuits (ASIC's) that include debugging ports, such as Joint Test Action Group (JTAG) debugging ports, for debugging the SoC ASIC's, and more particularly to debugging security mechanisms for such SoC ASIC's.

### BACKGROUND OF THE INVENTION

An application-specific integrated circuit (ASIC) is a chip that is custom designed for a specific application rather than a general-purpose chip such as a microprocessor. The use of ASIC's can improve performance over general-purpose central-processing units (CPU's). This is because ASIC's are “hardwired” to perform a specific job and thus may not incur the overhead of fetching and interpreting stored instructions. One type of ASIC may include one or more microprocessor, or processor, cores as well as embedded software. These types of ASIC's are known as system-on-chip (SoC) ASIC's. SoC ASIC's may include internal memory, as well as peripheral devices, such as Universal Serial Bus (USB) controllers, and other types of peripheral devices.

To debug an SoC ASIC, the processor thereof typically includes debugging functionality that permits information to be read from and written to the registers of the processor, as well as that permits the contents of memory to be dumped. Such debugging functionality may be externally accessed by one or more debugging ports. An example of such debugging ports within SoC ASIC's includes the Joint Test Action Group (JTAG) debugging ports, which provide a standard way by which debugging functionality of SoC ASIC's is accessed.

From a security standpoint, SoC ASIC's are advantageous because their program code and data can be protected from unauthorized parties, since read-only memories (ROM's) may be integrated within the ASIC's that store such program code and data. The program code and data are typically not directly externally accessible because the data bus of the ROM is not exposed outside its ASIC. However, the presence of debugging ports within an SoC ASIC means that program code and data stored in such a ROM may nevertheless be externally accessible, via the debugging ports. This is problematic from a security standpoint.

One solution to this problem is to not externally the JTAG debugging ports of an SoC ASIC. This solution is disadvantageous, however, because if these debugging ports are not externally exposed, debugging of the ASIC cannot be performed. Another solution is to fabricate two types of ASIC's: one in which the JTAG debugging ports are internally disabled and another in which the debugging ports are enabled. The former ASIC's are thus used for evaluation and development purposes, and the latter ASIC's are used for production purposes. However, this solution is also disadvantageous, because two types of chips have to be developed, increasing costs.

Other solutions to the problem of preventing access to internally stored program code and data within SoC ASIC's are likewise disadvantageous. For example, the JTAG debugging ports may be connected to terminal blocks that can be removed during the packaging stage of the ASIC's. However, since the debugging functionality and the debugging ports do actually remain present, third parties may nevertheless be able to access them. For these and other reasons, therefore there is a need for the present invention.

### SUMMARY OF THE INVENTION

The present invention provides a debugging security mechanism for system-on-chip (SoC) application-specific integrated circuits (ASIC's). An SoC ASIC of one embodiment of the invention includes at least a processor, a finite state machine (FSM), and a security mechanism. The processor exposes debugging ports, such as Joint Test Action Group (JTAG) debugging ports. The FSM permits instructions to be externally input to the debugging ports and data to be externally output from the debugging ports.

The security mechanism performs one of the following. First, the security mechanism can prevent access to at least a subset of the debugging ports, unless a security code externally input via a security interface of the security mechanism matches a predetermined internally stored security code. Second, the security mechanism can prevent at least a subset of the instructions from being processed, unless a security code externally input via a security code instruction asserted on the debugging ports matches the predetermined internally stored security code.

A method of an embodiment of the invention receives a security code on an externally exposed security interface of an SoC ASIC. A comparing mechanism compares the security code a predetermined security code internally stored within the SoC ASIC. The comparing mechanism outputs logic one where the security code matches the predetermined security code, to one or more logic AND gates corresponding to debugging ports, such as JTAG debugging ports, of a processor of the SoC ASIC, and otherwise outputs logic zero. Each logic AND gate has an output connected to a corresponding debugging port, a first input externally exposed by the SoC ASIC, and a second input connected to an output of the comparing mechanism.

A method of another embodiment of the invention receives a security code via a security code instruction asserted on debugging ports of a processor of an SoC ASIC. A comparing mechanism compares the security code to a predetermined security code internally stored within the SoC ASIC. The comparing mechanism outputs logic one where the security code matches the predetermined security code, to one or more logic AND gates corresponding to registers of the processor, including a control register, a data register, and an instruction code register, and otherwise outputs logic zero. Each logic AND gate has an output connected to a corresponding register, a first input connected to a decoder of the processor communicatively connected to an FSM of the SoC ASIC, and a second input connected to an output of the comparing mechanism.

Embodiments of the invention provide for advantages over the prior art. Embodiments of the invention enable debugging functionality and ports of an SoC ASIC to be accessed, where a third party has the correct security code. Otherwise, the debugging functionality and ports of the SoC ASIC cannot be accessed. Thus, malicious third parties, which do not have the correct security code, cannot access sensitive data and program code stored within the SoC ASIC via the debugging functionality and ports. Still other advantages, aspects, and embodiments of the invention will become apparent by reading the detailed description that follows, and by referring to the accompanying drawings.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1 is a diagram of a system-on-chip (SoC) application-specific integrated circuit (ASIC) having a debugging security mechanism, according to an embodiment of the invention.

FIG. 2 is a diagram of the SoC ASIC of FIG. 1 in which the debugging security mechanism is shown in more detail, according to an embodiment of the invention.

FIG. 3 is a flowchart of a method for providing debugging security in relation to the SoC ASIC of FIG. 2, according to an embodiment of the invention.

FIG. 4 is a diagram of the SoC ASIC of FIG. 3 in which the debugging security mechanism is shown in more detail, according to another embodiment of the invention.

FIG. 5 is a flowchart of a method for providing debugging security in relation to the SoC ASIC of FIG. 4, according to an embodiment of the invention.

### DETAILED DESCRIPTION OF THE DRAWINGS

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

### Overview

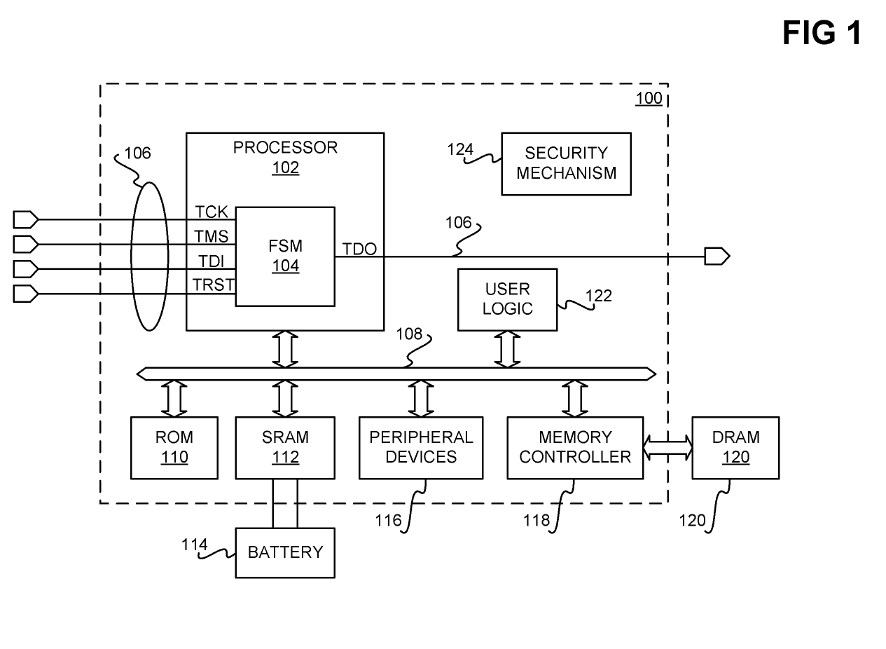

FIG. 1 shows a system-on-chip (SoC) application-specific integrated circuit (ASIC) 100, according to an embodiment of the invention. The SoC ASIC 100 is an ASIC, which is a chip that is custom designed for a specific application rather than a general-purpose chip such as a microprocessor. The SoC ASIC 100 is an SoC ASIC in that it includes a processor 102, memory 110 and 112, and/or peripheral devices 116. As can be appreciated by those of ordinary skill within the art, the SoC ASIC 100 may include other components, in addition to and/or in lieu of those depicted in FIG. 1.

The processor 102 is depicted as including a finite-state machine (FSM) 104. Alternatively, the FSM 104 may be external to the processor 102. The processor 102 exposes debugging ports 106, by which the SoC ASIC 100 can be externally debugged. The FSM 104 permits instructions to be externally input to the debugging ports 106, and permits data to be externally output from the debugging ports 106. The FSM 104 is a device designed with the operational states required to solve specific problems. The circuits are minimized, specialized, and optimized for this application. The FSM 104 is also referred to as a TAP controller, as can be appreciated by those of ordinary skill within the art.

In one embodiment, the debugging ports 106 may be Joint Tag Action Group (JTAG) debugging ports, as known within the art. Such JTAG debugging ports 106 include test data in (TDI), test data out (TDO), test clock (TCK), test mode select (TMS), and test reset (TRST) ports. The operation of these ports is known within the art, and is not specifically described here. However, it is noted that data is input into the TDI port and data is output onto the TDO port on a bit-by-bit basis in a serial manner. Thus, if an eight-bit byte, for example, is desired to be input, the bits of the byte are individually serially input into the TDI port, over successive clock cycles on the TCK port.

The processor 102 and/or the FSM 104 are communicatively connected to a data bus 108. Also communicatively connected to the data bus 108 are a read-only memory (ROM) 110, a static random-access memory (SRAM) 112, peripheral devices 116, a memory controller 118, and user logic 122. Other components, in addition to and/or in lieu of these components, may also be connected to the data bus 108.

The ROM 110 is a memory that is preprogrammed with data and/or program code, and the contents of which cannot be modified after construction of the ROM 110. By comparison, the SRAM 112 is random-access memory that can have its contents changed as needed. The SRAM 112 retains its contents after power is removed from the SoC ASIC 100, due to its attachment to an external battery 114.

The peripheral devices 116 may include Universal Serial Bus (USB) controllers, and other types of peripheral devices. The memory controller 118 enables the SoC ASIC 100 to control and/or access external memory, such as dynamic random-access memory (DRAM) 120. The user logic 122 includes program code that may be executed by the processor 102 to achieve desired functionality.

The security mechanism 124 is implemented in hardware, software, or a combination of hardware and software. The security mechanism 124 performs one of two functions. First, it prevents access to at least a subset of the debugging ports 106 unless a security code externally input via a security interface matches a predetermined internally stored security code. Second, it prevents at least a subset of instructions that can be externally input at the debugging permits 106 from being processed unless a security code externally input via a security code instruction asserted on the debugging ports 106 matches the predetermined internally stored security code. Each of these embodiments of the invention is now discussed in more detail.

### First Embodiment of SoC ASIC

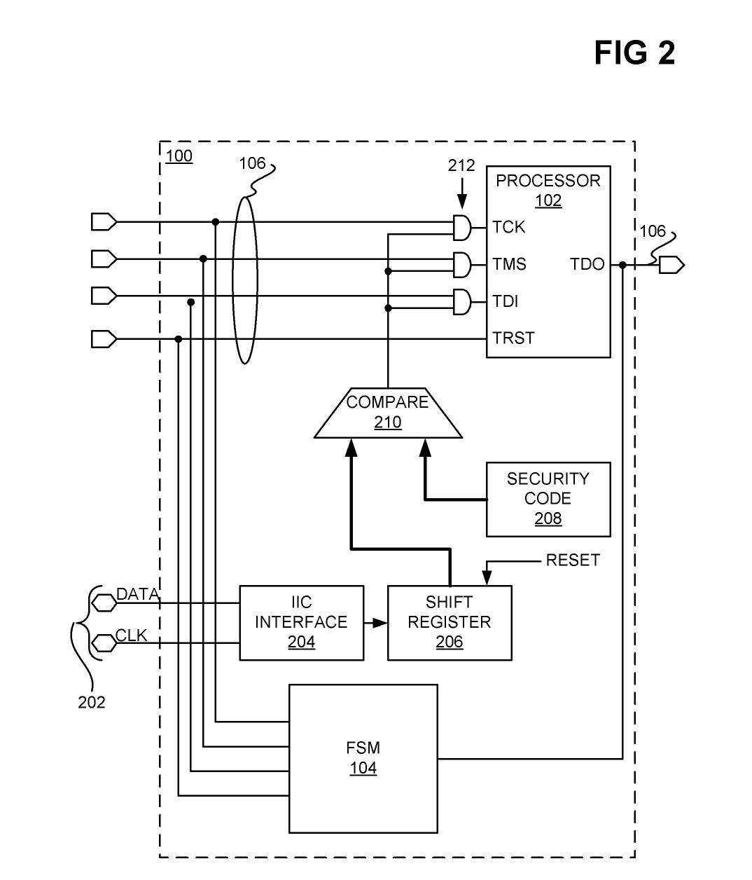

FIG. 2 shows the SoC ASIC 100 in which the security mechanism 124 prevents access to a subset of the debugging ports 106 unless a security code externally input matches a predetermined internally stored security code, according to an embodiment of the invention. The security mechanism 124 is implemented in the embodiment of FIG. 2 via one or more of: a security interface 202, an inter-integrated circuit (IIC, or I²C) interface 204, a shift register 206, an internal memory 208, a comparator 210, and a number of logic AND gates 212. The processor 102 and the FSM 104 of the SoC ASIC 100 are particularly depicted in FIG. 2. The other components of FIG. 1 are not depicted in FIG. 2, by comparison, for illustrative clarity and convenience.

The security interface 202 is an external interface that includes a data port and a clock (“Clk”) port. The security interface 202 is communicatively connected to a memory that stores a security code. The memory is connected to the SoC ASIC 100 for a party to obtain access to the debugging functionality of the SoC ASIC 100 via the debugging ports 106. If the security code stored on this memory matches the predetermined security code internally stored within the internal memory 208, then access to the debugging functionality via the debugging ports 106 is permitted, and otherwise it is not permitted.

Upon power up of the SoC ASIC 100, a reset signal is applied to the shift register 206 to clear all the bits stored within the shift register 206. Thereafter, the IIC interface 204 reads the security code stored in the memory attached to the security interface 202 on a bit-by-bit basis (i.e., serially), and stores each bit as read into the shift register 206. For example, in each successive clock cycle asserted on the data port of the security interface 202, the IIC interface 204 may read a bit of the security code stored in the memory attached to the data port of the security interface 202. The security interface 202 can be an interface that is present solely for the purposes of providing access to the debugging functionality of the SoC ASIC 100 via the debugging ports 106.

The security code loaded into the shift register 206 is input to a first input of a comparator 210, which is more generally a comparing mechanism. The predetermined security code stored within the internal memory 208 is input to a second input of the comparator 210. If the security code loaded into the shift register 206 matches the predetermined security code stored within the internal memory 208, then the output of the comparator 210 is logic one. Otherwise, if the security code loaded into the shift register 206 does not match the predetermined security code, or if there is no security code loaded into the shift register 206, then the output of the comparator 210 is logic zero.

The output of the comparator 210 is input to a first input of each of the logic AND gates 212. The logic AND gates 212 have outputs connected to a subset of the debugging ports 106, specifically the TCK, TMS, and TDI debugging ports. The second input of each of the logic AND gates 212 is externally exposed outside the SoC ASIC 100. The output of the comparator 210 thus determines whether the debugging ports 106 of the processor 102 are externally accessible. If the output of the comparator 210 is logic one, then the output of each of the logic AND gates 212 is determined by the externally asserted value of the second input of each logic AND gate, such that the debugging ports 106 are externally accessible. By comparison, if the output of the comparator 210 is logic zero, then the output of each of the logic AND gates 212 is always logic zero, such that the debugging parts 106 are not externally accessible.

In this way, the security mechanism 124 as implemented in the embodiment of FIG. 2 prevents access to the TCK, TMS, and TDI ports of the debugging ports 106 unless a security code externally input via the security interface 202 matches the predetermined security code internally stored within the memory 208. If the security code at the security interface 202 does not match the security code stored within the memory 208, or is not present, the output of the comparator 210 is logic zero, such that the TCK, TMS, and TDI ports of the debugging ports 106 of the processor 102 always receive logic zero as input. If the security code at the security interface 202 does match the security code stored within the memory 208, the output of the comparator 210 is logic one, such that the TCK, TMS, and TDI ports of the debugging ports 106 of the processor 102 receive the inputs presented on the second inputs of the logic AND gates 212.

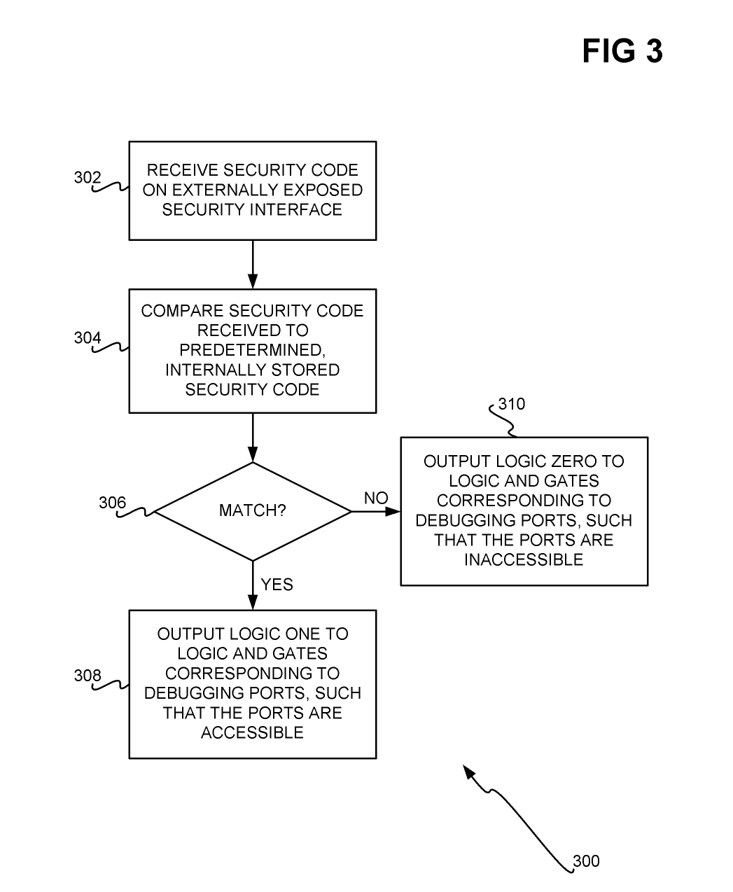

FIG. 3 shows a method 300 for controlling access to the debugging functionality of the SoC ASIC 100 of FIG. 2, according to an embodiment of the invention. A security code is received on the externally exposed security interface 202 (302). For instance, the IIC interface 204 serially receives this security code on a bit-by-bit basis and stores it within the shift register 206. The comparator 210 compares the security code within the shift register 206 to the predetermined security code internally stored within the memory 208 (304).

If the two security codes match (306), then the comparator 210 outputs a logic one to the logic AND gates corresponding to a subset of the debugging ports 106 (308). Otherwise, the comparator 210 outputs a logic zero to the logic AND gates corresponding to the subset of the debugging ports 106 (310). In this way, as has been described above, access to the debugging ports 106 is prevented unless the security code input at the security interface 202 matches the predetermined security code stored within the memory 208.

### Second Embodiment of SoC ASIC

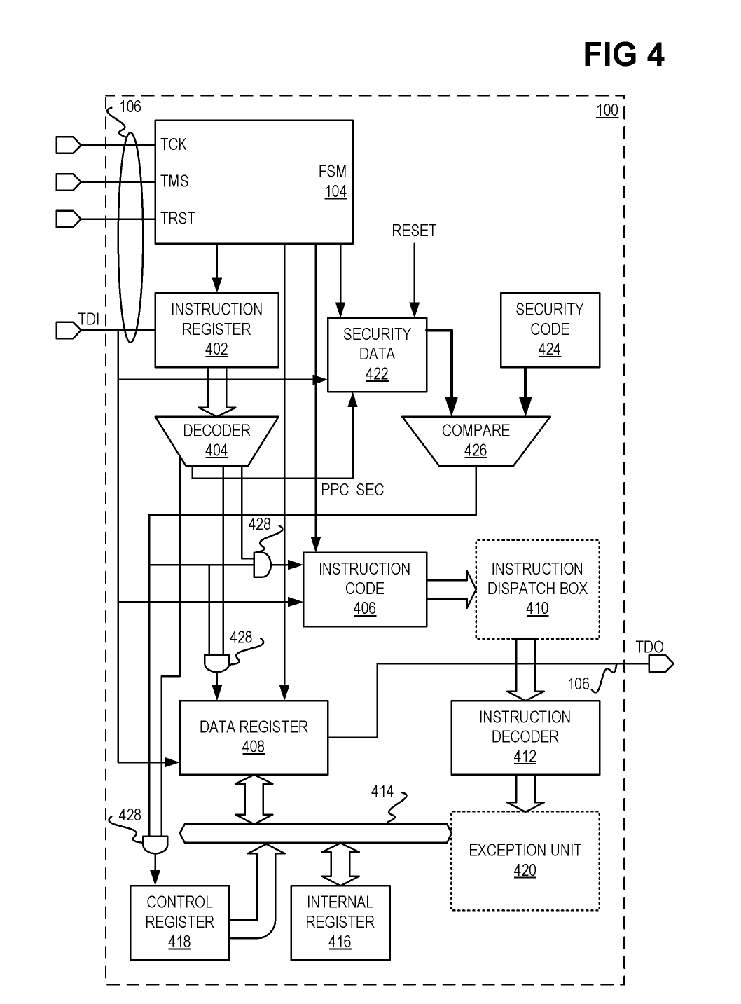

FIG. 4 shows the SoC ASIC 100 in which the security mechanism 124 prevents at least a subset of instructions from being process unless a security code externally input via a security code instruction asserted on the debugging ports 106 matches a predetermined internally stored security according, according to an embodiment of the invention. Several components of the processor 102 are specifically depicted in FIG. 4, including an instruction register 402, a decoder 404, an instruction code register 406, a data register 408, an instruction dispatch box 410, an instruction decoder 412, a bus 414, an internal register 416, a control register 418, and an execution unit 420. The security mechanism 124 is implemented in the embodiment of FIG. 4 via one or more of: a register 422, an internal memory 424, a comparator 426, and a number of logic AND gates 428. The FSM 104 is also particularly depicted in FIG. 4. The other components of FIG. 1 are not depicted in FIG. 4, by comparison, for illustrative clarity and convenience.

Operation of the debugging functionality of the SoC ASIC 100 is first described apart from the debugging security functionality, and then the debugging security functionality is described. Such operation of the debugging functionality in relation to Joint Test Action Group (JTAG) debugging is known within the art, and is summarized here without going into details to significant degree. Debugging is achieved by external assertion of an instruction on the TDI port of the debugging ports 106. These instructions may include Joint Test Action Group (JTAG) debugging instructions, such as EXTEST, SAMPLE, IDCODE, HIGHZ, CLAMP, and BYPASS, having instruction codes 0x0000000, 0x1110000, 0x1111100, 0x1111101, 0x1111110, and 0x1111111, respectively. The operation of these instructions is known within the art, and is not described here. The FSM 104 permits loading of an instruction within the instruction register 402, in a serial manner, upon assertion of the TMS port of the debugging ports 106, which selects the debugging mode.

The decoder 404 receives the asserted instruction from the instruction register 402, and decodes the instruction based on one of the three types: an actual instruction, data, or a control code. Depending on the type of the instruction asserted, the decoder 404 correspondingly selects one of the instruction code register 406, the data register 408, or the control register 418. Likewise, the FSM is able to correspondingly select one of the instruction code register 406 and the data register 408 depending on the debugging mode selected via the TMS port of the debugging ports 106. The instruction asserted on the TDI port of the debugging ports 106 is also provide to the instruction code register 406 and the data register 408.

Where the instruction code register 406 is selected, the instruction asserted on the TDI port is passed to the instruction dispatch box 410, which is a type of register, from which it is actually decoded within the instruction decoder 412 for execution by the execution unit 420. Where the data register 408 is selected, data is input from the TDI port of the debugging ports 106 to the bus 414, or from the bus 414 to the data register 408, depending on the type of instruction. The execution unit 420 thus outputs data via the TDO port of the debugging ports 106 through the bus 414 and the data register 408, where the data may be temporarily stored via the internal register 416. The internal register 416 may be used in other ways as well. Where the control register 418 is selected, the control register 418 takes on a desired value, and is input to the bus 414 for utilization by the execution unit 420 during instruction processing.

Besides the instructions EXTEST, SAMPLE, IDCODE, HIGHZ, CLAMP, and BYPASS, other instructions that can be employed in relation to the debugging functionality of the SoC ASIC 100 include PPC_INST, PPC_CNTR, PPC_DATA, and PPC_SEC, having instruction codes 0x11010000, 0x1101001, 0x1101010, and 0x1101111, respectively. None of these instructions except PPC_SEC (which is used to input security data to the memory 422), however, can be accessed unless a security code is first input at the TDI port of the debugging ports 106 that matches the predetermined security code stored within the internal memory 424. As such, only authorized third parties that have the security code are permitted access to confidential information stored within the ROM 110 and/or the SRAM 112. The manner by which debugging security is provided in this embodiment is now described.

When the SoC ASIC 100 is first powered up, a reset signal clears the register 422. A user enters another type of instruction, a PPC_SEC instruction, having an instruction code 0x1101111 in one embodiment, via the TDI port of the debugging ports 106, after having selected the appropriate debugging mode via the TMS port to the FSM 104. The decoder 404 recognizes this instruction stored within the instruction register 402, and selects the register 422. Thereafter, the user externally enters a security code via the TDI port, which is stored within the register 422, which may be a shift register, for instance. The security code loaded into the register 422 is input to a first input of the comparator 426, and the predetermined security code stored within the internal memory 424 is input to a second input of the comparator 426. Thereafter, the externally input security code is compared against the predetermined security code by the comparator 426, which is more generally a comparing mechanism.

The comparator 426 outputs a logic one if the security code entered via the TDI port of the debugging ports 106 matches the predetermined security code. Otherwise, the comparator 426 outputs logic zero. That is, if the security code entered via the TDI port does not match the predetermined security code, or if no security code is entered via the TDI port, the comparator 426 outputs logic zero. The output of the comparator 426 is provided as a first input to each of the logic AND gates 428, which correspond to the registers 406, 408, and 418. The second input to each of the logic AND gates 428 is provided by the decoder 404, upon the decoder 404 selecting a particular one of the registers 406, 408, and 418 based on the instruction being evaluated. The output of each of the logic AND gates 428 is connected to a corresponding one of the registers 406, 408, and 418.

Unless the output of the comparator 426 is one, the outputs of the logic AND gates 428 are always zero. This means that the decoder 404 is not able to select any of the registers 406, 408, and 418 for processing instructions provided on the debugging ports 106 unless a security code has first been entered within the register 422 that matches the security code stored within the internal memory 424. Furthermore, if the decoder 404 is not able to select any of the registers 406, 408, and 418, debugging functionality is effectively disable. That is, instructions cannot be entered into the register 406 for ultimate execution by the execution unit 420, data cannot be entered into or retrieved from the data register 408 for use by the execution unit 420 or for output on the TDO port, and the control register 418 cannot be controlled for use by the execution unit 420.

For example, if the output of the comparator 426 is logic one, then the output of each of the logic AND gates 428 is determined by the decoder 404, such that the decoder 404 is able to select the registers 406, 408, and 418 in response to debugging instructions asserted on the debugging ports 106. By comparison, if the output of the comparator 426 is logic zero, then the output of each of the logic AND gates 428 is always logic zero, such that the decoder 404 is unable to select any of the registers 406, 408, and 418. In this way, the security mechanism 124 as implemented in the embodiment of FIG. 4 prevents utilization of the debugging functionality of the SoC ASIC 100 unless a security code externally input via the TDI port of the debugging ports 106 matches the predetermined security code internally stored within the memory 424.

If the security code externally input via the TDI port of the debugging ports 106 does not match the security code stored within the memory 424, or is not present, the output of the comparator 426 is logic zero, such that the decoder 404 is unable to select the registers 406, 408, and 418. If the security code input via the TDI port does match the security code stored within the memory 424, the output of the comparator 426 is logic one, such that the decoder 404 is able to select the registers 406, 408, and 418. Therefore, whether instructions input via the debugging ports 106 can be evaluated or not depends on whether the decoder 404 of these instructions is able to appropriately select the registers 406, 408, and 418, or is unable to appropriately select these registers.

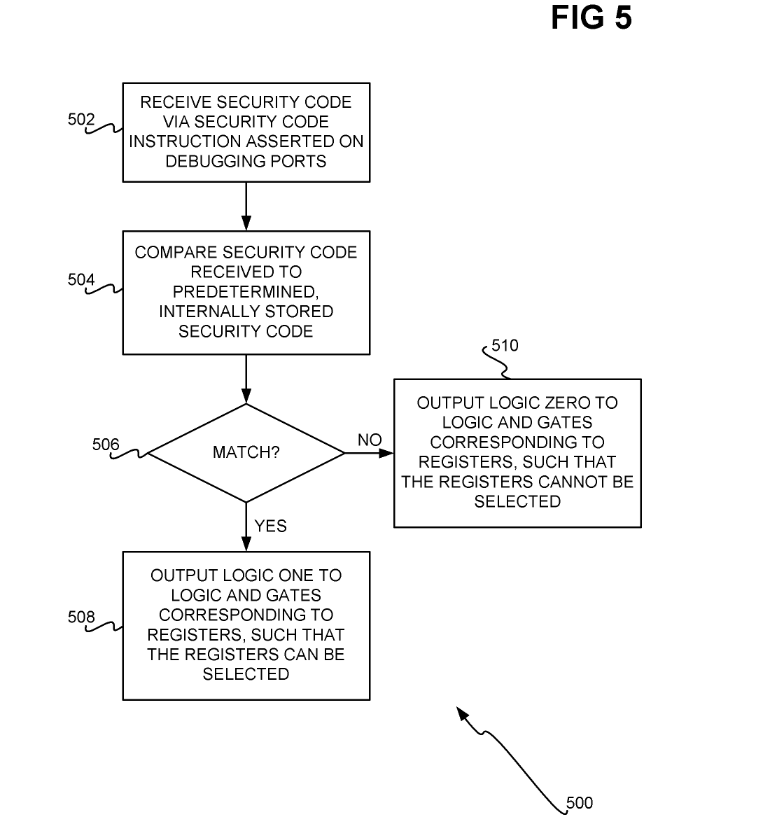

FIG. 5 shows a method 500 for controlling access to the debugging functionality of the SoC ASIC 100 of FIG. 4, according to an embodiment of the invention. A security code is received via a security code instruction asserted on the debugging ports 106 (502). For instance, first a security code instruction is asserted on the debugging ports 106 to indicate that a security code is going to be entered next. Once this security code instruction has been received, the data that follows is stored as the externally input security code within the register 422, as has been described.

The comparator 426 compares the security code within the register 422 to the predetermined security code internally stored within the memory 424 (504). If the two security codes match (506), then the comparator 426 outputs a logic one to the logic AND gates corresponding to the registers 406, 408, and 418 (508). Otherwise, the comparator 426 outputs a logic zero to the logic AND gates corresponding to these registers (510). In this way, as has been described above, at least a subset of debugging instructions are prevented from being processed (i.e., evaluated), unless the security code input at the debugging ports 106 matches the predetermined security code stored within the memory 424.

It is noted that, although specific embodiments have been illustrated and described herein, it will be appreciated by those of ordinary skill in the art that any arrangement calculated to achieve the same purpose may be substituted for the specific embodiments shown. This application is thus intended to cover any adaptations or variations of embodiments of the present invention. Therefore, it is manifestly intended that this invention be limited only by the claims and equivalents thereof.

We claim:

1. A system-on-chip (SoC) application-specific integrated circuit (ASIC) comprising:
a processor exposing a plurality of debugging ports;
a finite state machine (FSM) to permit instructions to be externally input to the debugging ports and to permit data to be externally output from the debugging ports; and,
a security mechanism to one of:
prevent access to at least a subset of the debugging ports unless a security code externally input via a security interface of the security mechanism matches a predetermined internally stored security code; and,
prevent at least a subset of the instructions from being processed unless a security code externally input via a security code instruction asserted on the debugging ports matches the predetermined internally stored security code.

2. The SoC ASIC of claim 1, wherein the security mechanism is to prevent access to at least a subset of the debugging ports unless the security code externally input via the security interface of the security mechanism matches a predetermined internally stored security code.

3. The SoC ASIC of claim 2, wherein the security mechanism comprises:
the security interface to which an external memory storing the security code is connected to externally input the security code into the security mechanism;
an internal memory storing the predetermined internally stored security code;
a comparing mechanism to compare the security code externally input to the predetermined internally stored security code, to output logic one where the security code externally input and the predetermined internally stored security code match, and otherwise to output logic zero; and,
one or more logic AND gates corresponding to the subset of the debugging ports, each logic AND gate having an output connected to a corresponding debugging port, a first input externally exposed by the SoC ASIC, and a second input connected to an output of the comparing mechanism.

4. The SoC ASIC of claim 3, wherein the security mechanism further comprises:
a shift register to store the security code externally input, and to output the security code externally input to a first input of the comparing mechanism, the internal memory outputting the predetermined internally stored security code to a second input of the comparing mechanism; and,
an inter-integrated circuit (IIC) interface to serially receive the security code externally input on a bit-by-bit basis and to store the security code within the shift register.

5. The SoC ASIC of claim 1, wherein the security mechanism is to prevent at least the subset of the instructions from being processed unless the security code externally input via the security code instruction asserted on the debugging ports matches the predetermined internally stored security code.

6. The SoC ASIC of claim 5, wherein the security mechanism comprises:
a comparing mechanism to compare the security code externally input to the predetermined internally stored security code, to output logic one where the security code externally input and the predetermined internally stored security code match, and otherwise to output logic zero; and,
a plurality of logic AND gates corresponding to a plurality of registers of the processor including a control register, a data register, and an instruction code register, each logic AND gate having an output connected to a corresponding register, a first input connected to a decoder of the processor communicatively connected to the FSM, and a second input connected to an output of the comparing mechanism.

7. The SoC ASIC of claim 6, wherein the security mechanism further comprises:
a register to store the security code externally input via the security code instruction asserted on the debugging ports, the register outputting the security code externally input to a first input of the comparing mechanism; and,
an internal memory storing the predetermined internally stored security code and outputting the predetermined internally stored security code to a second input of the comparing mechanism.

8. The SoC ASIC of claim 1, wherein the debugging ports are Joint Test Action Group (JTAG) ports.

9. The SoC ASIC of claim 8, wherein the JTAG ports comprise:
a test data in (TDI) port;
a test data out (TDO) port;
a test clock (TCK) port; and,
a test mode select (TMS) port.

10. The SoC ASIC of claim 1, further comprising:
memory communicatively connected to the processor; and,
peripheral devices communicatively connected to the processor.

11. A method comprising:
receiving a security code on an externally exposed security interface of a system-on-chip (SoC) application-specific integrated circuit (ASIC);
comparing the security code to a predetermined security code internally stored within the SoC ASIC, by a comparing mechanism;
outputting logic one where the security code matches the predetermined security code to one or more logic AND gates corresponding to a plurality of debugging ports of a processor of the SoC ASIC, by the comparing mechanism; and,
otherwise outputting logic zero to the logic AND gates, by the comparing mechanism,
wherein each logic AND gate has an output connected to a corresponding debugging port, a first input externally exposed by the SoC ASIC, and a second input connected to an output of the comparing mechanism.

12. The method of claim 11, wherein access to the debugging ports is prevented unless the security code matches the predetermined security code.

13. The method of claim 11, wherein receiving the security code on the externally exposed security interface comprises an inter-integrated circuit (IIC) interface serially receiving the security code on a bit-by-bit basis and storing the security code within a shift register.

14. The method of claim 11, wherein the debugging parts are Joint Test Action Group (JTAG) ports.

15. The method of claim 14, wherein the JTAG ports comprise:
a test data in (TDI) port;
a test data out (TDO) port;
a test clock (TCK) port; and,
a test mode select (TMS) port.

16. A method comprising:
receiving a security code via a security code instruction asserted on a plurality of debugging ports of a processor of a system-on-chip (SoC) application-specific integrated circuit (ASIC);
comparing the security code to a predetermined security code internally stored within the SoC ASIC, by a comparing mechanism;
outputting logic one where the security code matches the predetermined security code to one or more logic AND gates corresponding to a plurality of registers of the processor including a control register, a data register, and an instruction code register, by the comparing mechanism; and,
otherwise outputting logic zero to the logic AND gates, by the comparing mechanism,
where each logic AND gate has an output connected to a corresponding register, a first input connected to a decoder of the processor communicatively connected to a finite state machine (FSM) of the SoC ASIC, and a second input connected to an output of the comparing mechanism.

17. The method of claim 16, wherein at least a subset of instructions capable of being externally input to the debugging ports are prevented from being processed unless the security code matches the predetermined security code.

18. The method of claim 16, wherein receiving the security code via the security code instruction asserted on the debugging ports comprises the FSM receiving the security code and the security code instruction asserted on the debugging ports.

19. The method of claim 16, wherein the debugging parts are Joint Test Action Group (JTAG) ports.

20. The method of claim 19, wherein the JTAG ports comprise:
a test data in (TDI) port;
a test data out (TDO) port;
a test clock (TCK) port; and,
a test mode select (TMS) port.
